(19) United States
(12) Patent Application Publication
(10) Pub. No.: US 2013/0338873 A1
(43) Pub. Date: Dec. 19, 2013

(54) VEHICLE SERVICE AUCTION SYSTEMS AND METHODS

(71) Applicant: Arvin Baalu, Bangalore (IN)

(72) Inventor: Arvin Baalu, Bangalore (IN)

(73) Assignee: Harman International Industries, Inc., Stamford, CT (US)

(21) Appl. No.: 13/524,308

(22) Filed: Jun. 15, 2012

(51) Int. Cl. G06Q 30/08; G01C 21/00; G06F 7/00

(52) U.S. Cl. 701/31.4; 705/26.3; 701/400

(57) ABSTRACT

Various embodiments relates to a vehicle servicing auction method and system. Based on vehicle diagnostic information transmitted to a vehicle servicing bidding, a vehicle servicing bidding event may be initiated. The bidding event may include submitting requests for bids to one or more vehicle service providers and receiving bids from the vehicle service providers for servicing the vehicle based on a servicing need determined from the vehicle diagnostic information. One or more bids may be received from one or more vehicle service providers and the bids output at a vehicle computing system. The user may select a bid as acceptance of the bid at the vehicle computing system. In some embodiments, the bids may be sorted by bid amount. Location information for the vehicle service provider who submitted the user selected bid may be output. A route to the vehicle service provider may be generated based on the location information.

### TECHNICAL FIELD

Various embodiments relate to systems and methods for automatically triggering bidding by vehicle service providers for servicing a vehicle in response to one or more vehicle diagnostic concerns.

### BACKGROUND

Vehicle diagnostic tools have been used for years and, over time, have become more sophisticated. One example of proposed tool is disclosed in US Patent Application Number US 2002/0016655 to Joao describing an apparatus and method for processing and/or for providing vehicle information and/or maintenance information. Joao specifically discloses an apparatus and method for processing vehicle information and/or vehicle maintenance information which includes a memory device for storing at least one of vehicle diagnostic information, vehicle repair information, vehicle maintenance information, and vehicle servicing information. Additionally, the apparatus includes a receiver for receiving information regarding at least one of a vehicle problem, a vehicle malfunction, and a vehicle state of disrepair. The apparatus also includes a processor for processing the information regarding at least one of a vehicle problem, a vehicle malfunction, and a vehicle state of disrepair, in conjunction with at least one of vehicle diagnostic information, vehicle repair information, vehicle maintenance information, and vehicle servicing information. The processor generates at least one of a diagnostic report, a repair report, a maintenance report, and a servicing report. The apparatus also includes a transmitter for transmitting at least one of the at least one of vehicle diagnostic information, vehicle repair information, vehicle maintenance information, and vehicle servicing information, to a communication device associated with an individual.

Another example is disclosed in U.S. Pat. No. 6,330,499 to Chou et al. which discloses a system and method for vehicle diagnostics and health monitoring. The system and method for vehicle diagnostic and health monitoring includes a client computer device within the vehicle, coupled to the vehicle's monitoring systems, for data management, remote session management and user interaction, a communication system, coupled to the client computer device, for providing remote communication of data including data derived from internal monitoring systems of the vehicle, and a remote service center including a vehicle data store, a server computer, a diagnostic engine, and a communicator for communicating the results of analysis of vehicle information to the client computer device via the communication system.

Yet another example is disclosed in U.S. Pat. No. 7,920,944 to Gould et al. which discloses a vehicle diagnostic test and reporting method. Specifically a system and method for providing user-initiated vehicle diagnostic testing and reporting in a telematics-enabled vehicle is disclosed. In the method, a request for a vehicle diagnostic test is received from the driver through a user interface of a telematics unit on the vehicle. A simplified initial diagnostic check is made and a first voice message is played for the driver that provides information concerning any detected vehicle problem. The method then undergoes a more complete diagnostic check and the resulting diagnostic information is used to select and play a second voice message that provides instructions for taking corrective action to fix the detected problem. Communication with a live advisor is also provided by way of a cellular or other wireless carrier system.

One challenge with using these tools is the additional steps that a vehicle owner must take in order to engage a service facility for servicing the vehicle. For example, such servicing is typically performed once a service facility has already been engaged. One proposal for selecting a service provider is disclosed in US Publication Number 2008/0040129 to Cauwels et al. According to the publication, incentives are provided that relate to product services. In a computer-implemented method for providing an incentive related to a vehicle maintenance service, a registration request is received from a customer. The registration request may include a vehicle identification number of a vehicle associated with the customer. Further, the method may include determining a maintenance reminder trigger for a maintenance service for the vehicle based on the registration request and vehicle data stored in a database and sending a maintenance reminder for the maintenance service to the customer. Additionally, a request for offers may be received from the customer to a plurality of vendors that are configured to provide the maintenance service. Also, a bid may be received from each vendor for providing the maintenance service, and provided to the customer. The method also includes receiving a selection of at least one of the bids by the customer.

### SUMMARY

One aspect relates to a computer-implemented method for presenting one or more vehicle service providers at a vehicle computing system. The computer-implemented method includes receiving vehicle diagnostic information at the vehicle computing system. The diagnostic information is transmitted from the vehicle computing system to a vehicle servicing bidding module configured to manage a vehicle service bidding operation. The vehicle service bidding operation includes submitting requests for bids to one or more vehicle service providers and receiving one or more bids from the one or more vehicle service providers for servicing the vehicle based on a servicing need determined from the vehicle diagnostic information.

One or more bids are received at the vehicle computing system from the one or more vehicle service providers and output at the vehicle computing system. A user selects a bid from the one or more bids at the vehicle computing system which may be selected orally. The selection of the bid may serve as an acceptance of the bid. Location information for the vehicle service provider who submitted the user selected bid is output and a route to the vehicle service provider generated based on the location information.

In some embodiments, the location information is stored in a database remote from the vehicle computing system. The computer-implemented method includes automatically inputting the location information received at the vehicle computing system from the database to a navigation module at the vehicle computing system for generating the route. The location information may be output as points on a route and/or as points of interest.

In some embodiments, a request for a specified service time may be transmitted with the requests for bids. The bids may be received from the one or more vehicle service providers that can service at the requested service time. The specified service time may be for immediate servicing.

Another aspect relates to a system for providing at a vehicle computing system one or more vehicle service providers along a route. The system has at least one computer which may be configured to receive a servicing need for a vehicle and a location of the vehicle. Based on the servicing need and the location of the vehicle, one or more vehicle service providers may be identified within a geographic area who are able to service the servicing need.

A vehicle servicing bidding event may be automatically triggered in response to receiving the servicing need which may be based on diagnostic information detected by one or more vehicle sensors and/or a is user defined servicing need. The vehicle servicing bidding event may be with one or more vehicle service providers within the geographic area who are able to service the servicing need. Upon completion of the vehicle servicing bidding event, all received bids may be sorted based on an amount of the bid. The sorted bids may be transmitted for output from a vehicle computing system.

In some embodiments, the at least one computer may be configured to initiate a timer during the vehicle servicing bidding event. The timer may be initiated to monitor a time limit for receiving the bids from the one or more vehicle service providers. Bids may be transmitted which are received within the time period as determined based on the timer.

In some embodiments, the location of the one or more vehicle service providers and services of the one or more vehicle service providers may be received from a database communicating with the at least one computer to identify the one or more vehicle service providers.

In some embodiments, the at least one computer is further configured to receive a request for a specified service time. The request for the specified servicing time may be transmitted with the requests for bids during the vehicle servicing bidding event. During the event, each of the one or more vehicle service providers submit a bid based on whether the service can be performed at the specified servicing time. Accordingly, bids may be received from the one or more vehicle service providers within the geographic area who are able to service the servicing need at the specified servicing time.

In some embodiments, a route may be generated at the vehicle computing system based on the location of the vehicle service provider submitting a bid which is selected by the vehicle user. The location information may be stored in a database remote from the vehicle computing system. The vehicle computing system may be configured to automatically input the location information received from the database to a navigation module at the vehicle computing system for generating the route.

Another aspect relates to a computer program product embodied in a computer readable medium for presenting at a vehicle computing system one or more vehicle service providers along a route. The computer program product may have instruction for receiving a servicing need for a vehicle and receiving a location of the vehicle. Based on the servicing need and the location of the vehicle, further instructions may include identifying one or more vehicle service providers within a geographic area able to service the servicing need.

Additional instructions may include automatically triggering a vehicle servicing bidding event in response to receiving the servicing need. During the event, one or more bids are received from one or more vehicle service providers within a geographic area and capable of servicing the servicing need. Further instructions may include transmitting the one or more bids for output at a vehicle computing system. Further instructions may include receiving a user selection of a bid selected at the vehicle computing system. Location information for the vehicle service provider who submitted the user selected bid may be output. The location information may be displayed on a navigation display.

In some embodiments, the vehicle service provider location is within a radius of the vehicle.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 illustrates the system architecture of a vehicle computing system;

FIG. 2 illustrates the system architecture of a vehicle service auction system;

FIG. 3 illustrates a process for gathering data used in the vehicle service auction system;

FIG. 4 illustrates the operation for generating and requesting bids from vehicle service providers;

FIG. 5 illustrates the operation performed by the vehicle service provider for responding to the request for bid;

FIG. 6 illustrates the operation of the vehicle service auction system after one or more bids are received from the vehicle service providers; and

FIG. 7 illustrates a reporting procedure of the vehicle service auction system.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. Additionally, the disclosure and arrangement of the figures is non-limiting. Accordingly, the disclosure and arrangement of the figures may be modified or re-arranged to best fit a particular implementation of the various embodiments of the invention.

Vehicle servicing and repair can be expensive, especially when a maintenance warranty on the vehicle has expired (if there ever was one). As vehicles owners become more cost conscious, it is increasingly more important for them to find a cost-effective vehicle service provider without sacrificing work quality. Typically, such a vehicle service provider may be found through referrals and recommendations from others. While this solution may suit the needs of some, it is likely that there may be other vehicle service providers unknown to the referral source that also provide inexpensive and possibly better service.

For those who are new to a town or are visitors, they may not have a referral source. Of course, researching the cost and quality of service from every vehicle service provider within a certain vicinity to find the best provider is unfeasible and unrealistic. Further, the quality of service usually cannot be determined until after the service is complete.

A vehicle owner may also have an immediate need for a vehicle service provider while using a vehicle. In this case, researching even some service providers or asking for a referral may not be possible.

A system in the vehicle which automatically presents a selection of vehicle service providers to a vehicle occupant in response to a vehicle diagnostic concern received from the vehicle may be more useful and helpful to the vehicle user. In some embodiments, the results may be based on one or more bids submitted by the vehicle service provider. Further, the vehicle user can be directly navigated to the vehicle service provider once a bid is selected.

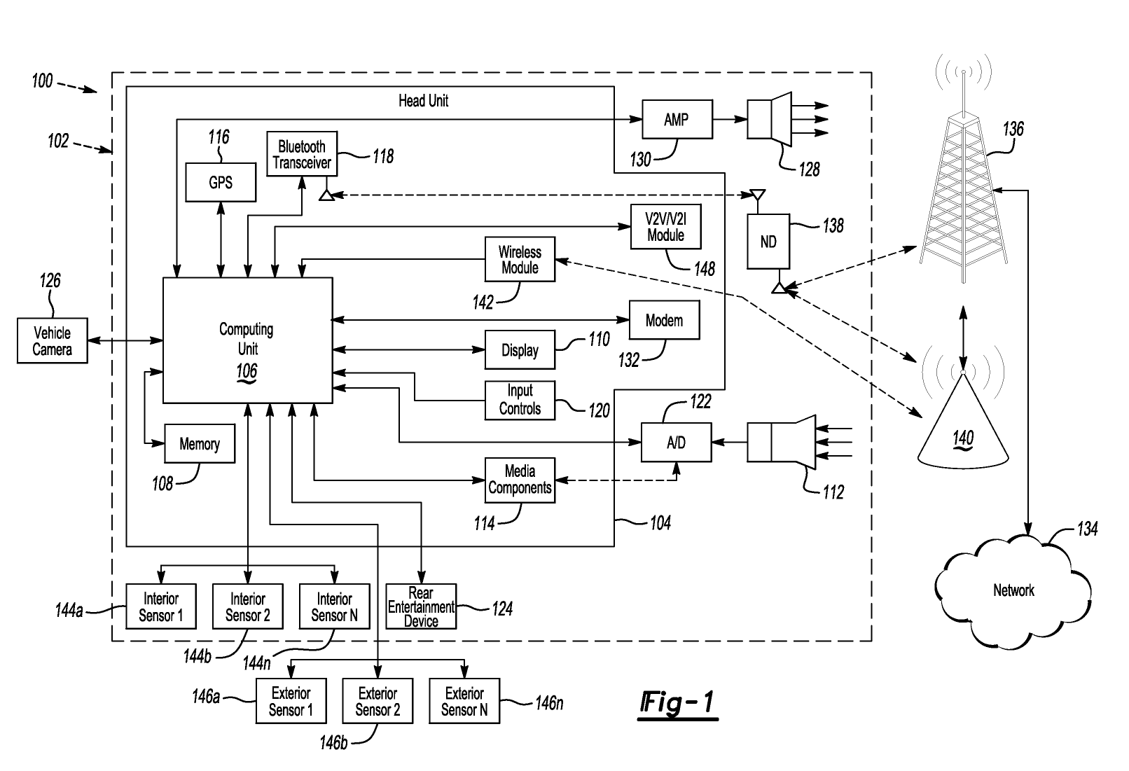

FIG. 1 is a block diagram of a vehicle computing system (VCS) 100. Within the vehicle 102, a head unit 104 may have a computing unit 106 having one or more processors (not shown) that provide for on-board processing of instructions and controls received by the VCS 100. Data that may be received and processed by the processor 106 may be stored in memory 108. The memory 108 may include non-persistent or volatile memory, such as (and without limitation) random access memory (RAM), and persistent or non-volatile memory, such as (and without limitation) a hard disk drive (HDD) or flash memory.

The head unit 104 may also include a visual front end interface, such as a display 110, located in the vehicle. The display 110 may be an LCD display or a graphical display. In some embodiments, the interface may have a touch sensitive screen. In additional or alternative embodiments, the interaction with the VCS 100 may occur through, button presses, audible speech and/or speech synthesis and displayed on display 110.

The VCS 100 is also provided with a number of different modules through which the user can interface or interact with the VCS 100. For example, the vehicle 102 may be provided with a microphone 112, one or more media components 114 (e.g., and without limitation, one or more input modules, such as, and without limitation, an auxiliary input or USB input for connected devices, a radio, a CD/DVD player, satellite radio, and the like), a GPS module 116, and a BLUETOOTH module 118. Additional media components may include one or more rear entertainment devices 124. The rear entertainment device 124 may include one or more media players (e.g., a DVD player) and one or more displays visible to rear seat passengers from which video, picture and/or audio may be output.

The computing unit 106 may be in communication with a vehicle network (not shown) that communicates data to and from the various modules. Non-limiting examples of a vehicle network include an SAE J1850 bus, a CAN bus, a GMLAN bus, and any other like vehicle data buses. The vehicle network may additionally or alternatively be a network for use with infotainment systems such as a media oriented system transport (MOST), Ethernet, or an Audio-Video Bridge (AVB) network.

Additional modules of the VCS 100 may include one or more vehicle cameras 126. The vehicle cameras 126 may be front or rear view cameras and/or in the vehicle. For purposes of simplicity, a single camera 126 is shown at the front of the vehicle 102. The output of the camera(s) 126 may be presented on the display 110 and/or on one or more rear-entertainment devices 126.

One or more input controls 120 may also be provided to allow a user to swap between and activate various modules. Signals passing from the microphone 120 may pass through one or more analog-to-digital converters 122 before being passed to the processor 106 and vice-versa. Additionally, signals to and from some media components 114 (e.g., AM/FM radio) may also pass through one or more A/D converters 122 before being passed to or from the processor 106. For purposes of simplicity, one A/D converter 122 is shown. However, multiple A/D converters 122 may be arranged in the system 100.

The output from one or more vehicle modules of the VCS 100 may be audible and/or visual output. Audible output may be output from one or more in-vehicle speakers 128. The speaker(s) 128 may be connected to an amplifier 130 and may receive its signal from the processor 106. In some cases, the signals may pass through a digital-to-analog (D/A) converter (not shown). Visual outputs may be output on the display 110 and/or on one or more rear entertainment devices 124.

The vehicle 10 may include an on-board modem 132 for two-way communication of data and messages between the vehicle 102 and an external network 134. As a non-limiting example, modem 132 may be a USB cellular modem. As an alternative example, the modem may be an embedded modem in the vehicle 102. The data and messages may be exchanged by communicating with the one or more cellular towers 136.

Alternatively, via a BLUETOOTH transceiver 118 in the vehicle, a communication or pairing may be made automatically with a user's portable (sometimes referred to as “nomadic”) device 138 (e.g., mobile phone, smart phone, PDA, or any other device having wireless remote network connectivity) after a vehicle key-on. In some embodiments, pairing the portable device 138 and the BLUETOOTH transceiver 118 may be instructed through one or more buttons or similar input (not shown). The one or more buttons may be one or more hard keys located in the vicinity of the vehicle driver (e.g., and without limitation, on the steering wheel, in the center console, or near the display 110) and/or one or more soft keys shown on the display 18. The soft keys may or may not be touch-sensitive (e.g, on a touchscreen display). Additionally or alternatively, the soft keys may be one or more physical buttons mapped to the one or more soft keys.

In yet an alternative embodiment, connectivity may be accomplished using a USB connection linking the nomadic device 138 with the head unit 104 via a USB module. In some embodiments, this connection may only be enabled using an accessory protocol. Non-limiting examples of accessory protocols include the IPHONE accessory protocol or the ANDROID accessory protocol.

Using the portable device 138, communication with an external network 134 may be accomplished through, for example, communication with a cellular tower 136 and/or a wireless access point 140. Data may be communicated from the vehicle 102 (e.g., from the processor 106) to the network 134 utilizing, for example, a data-plan, data over voice, or DTMF tones associated with nomadic device 54.

Additionally or alternatively, the vehicle 10 may be outfitted with one or more wireless modules 142 for wireless communication with the network 134. A non-limiting example of such a wireless communication is any communication system meeting the 802.11 IEEE standard such as WiFi or WiMax. To communicate with the network 134, a connection may be made to a wireless hotspot 140 (or wireless access point) which may be outside and remote from the vehicle (e.g., and without limitation, at a publically available hotspot venue). In some embodiments, a wireless hotspot may be created in the vehicle and communication with the network 134 may be accomplished by wirelessly connecting one or more compatible devices in the vehicle with the in-vehicle wireless access point. For purposes of simplicity and clarity, FIG. 1 shows an external hotspot 140.

The processor 106 may be provided with an operating system including an API to communicate with modem application software. The modem application software may access an embedded module or firmware on the BLUETOOTH transceiver 118 to complete wireless communication with a remote BLUETOOTH transceiver (such as that found in a nomadic device).

The nomadic device 138 may be capable of voice band and/or broadband data communication. A user may be able to transfer data over the voice band using a technique called frequency division multiplexing. Thus, a user of the nomadic device 138 may be able to talk over the device while data is being transferred. If the user has a dataplan associated with the nomadic device 138, broadband transmission may be possible.

Incoming data to the VCS 100 may be passed through the nomadic device 138 via a data-over-voice or data plan through the onboard BLUETOOTH transceiver 118 and into the vehicle's internal processor 106. Alternatively, the data may be passed through the embedded modem 132 via cellular communication to the processor 106. Alternatively, the data may be passed through the wireless module 142 via, e.g., a WiFi connection, to the processor 106. Data may be stored in the memory 108 of the VCS 100.

Additional sources that may interface with the VCS 100 may include personal navigation device, vehicle navigation device, onboard GPS devices, or remote navigation systems having connectivity to network 134. Further, the processor 106 could be in communication with a variety of other auxiliary devices connected through a wireless or wired connection. Auxiliary devices may include, but are not limited to, personal media players, wireless health devices, portable computers, and the like.

Additionally communicating with the computing unit 106 may be one or more interior sensors 144a, 144b . . . 144n (generally referred to herein as interior sensors 144) and one or more exterior sensors 146a, 146b . . . 146n (generally referred to herein as exterior sensors 146). Interior sensors 144 may monitor one or more vehicle components for vehicle concerns. Exterior sensors 146 may monitor events outside of the vehicle. As one non-limiting example, exterior sensors 146 may be proximity sensors for detecting objects near the vehicle.

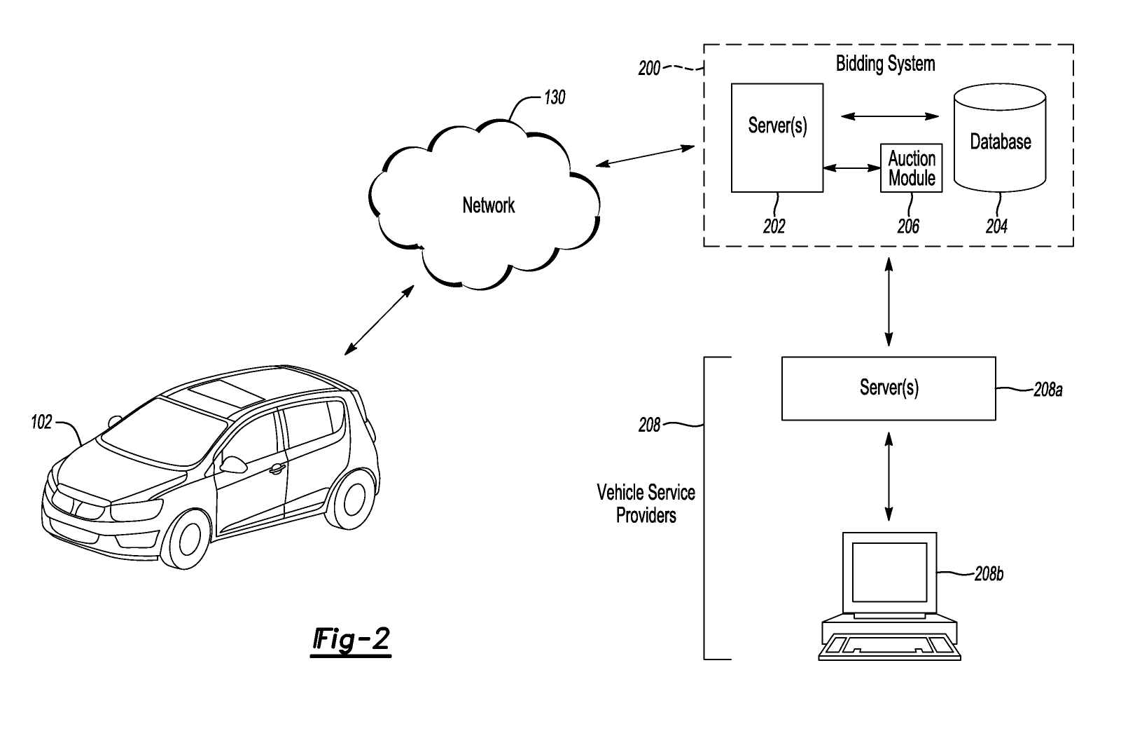

FIG. 2 is a block diagram of a vehicle service auction system. The vehicle 102, via the head unit 104 and over network 134, may communicate with a remote central system 200. In some embodiments, the network 134 may be the Internet. The remote central system 200 may be comprised of one or more servers 202 and one or more databases 204. Executing on the server(s) 202 may be one or more auction modules 206 which manage the operation of the vehicle servicing auction. The module(s) 206 may be software having instructions for performing the auction operation. Details of the operation of the auction module(s) 206 will be further described below.

The database(s) 204 may include data relating to the vehicle service providers and data relating to the vehicle and vehicle owners. In some embodiments, the data for the vehicle service auction system may be in multiple, separate databases (not shown for purposes of clarity). The data may include profile information of the vehicles, vehicle owners, and the vehicle service providers (VSP). Vehicle profile information may include, but is not limited to, vehicle make and model, vehicle identification number (VIN), vehicle year, vehicle mileage, vehicle warranty information, vehicle service history, and other vehicle information. Vehicle owner profile information may include, but is not limited to, name and contact information (e.g., address, telephone number(s), email addresses) of each vehicle owner. In some embodiments, vehicle owners must be a subscriber to the auction service in which case the profile information may also include subscription information, including if the owner's subscription is current. In some further embodiments, a vehicle owner may include in a profile the amount the vehicle owner is willing to pay (e.g., as a range) for one or more vehicle services why may be used by the VSP in determining whether or not to submit a bid. The databases may be relationally linked in order to associate a vehicle with a vehicle owner. In alternative embodiments, the vehicle data and the vehicle service provider data may be in one database. The vehicle owner information and the vehicle information may be manually and/or automatically input and stored in the database 204. For example, some information may be automatically obtained from the vehicle, via network 134, and stored in the database 204 when the vehicle is keyed on.

The vehicle service provider profile may include vehicle service provider names, contact information (including, but not limited, address, telephone number, and email address), hours of operation, types of services provided, vehicles serviced, and discount and coupons provided. In some embodiments, additional profile information may include standard costs charged by the vehicle service provider for repair or maintenance services. In alternative or additional embodiments, the vehicle service provider may provide a general bid range defining the range that the service provider may charge for the service. Further, the vehicle service provider may include an amount by which to decrement a bid within the range in order to be competitively priced as a low cost provider. In operation, the range may be compared to bids from other vehicle service providers by the auction module 206 and the bid decremented based on the comparison and according to the decrement value defined by the service provider. The stored cost information (whether a specific cost or a range) may be used to automatically submit bids without human intervention. However, the bids may alternatively be submitted manually.

A vehicle service provider system 208 may be used by the VSP to receive bid requests and submit bids for a vehicle service. Each VSP may interface with the central system 200 via one or more VSP systems 208. The bid requests may be received by each VSP at one or more computer terminals 208b via one or more servers 208a. Additionally, the VSP may submit bids via the one or more terminals 208b which may be transmitted to the central system 200 via one or more servers 208a. The VSP may also input profile information from the terminal 208b. The VSP may interface with the auction system 200 to received bid requests and submit bids via a textual and/or graphical interface. In some embodiments, the interface may be a web-based interface. Further, communication between the VSP system 208 and the central system 200 may be via the Internet.

In some embodiments, software may be executing on the head unit 104, or on a nomadic device having a connection (e.g., wired or wireless) to the head unit 104, providing an interface to communicate with the system 200. The software may be a mobile application which may be downloaded from the Internet.

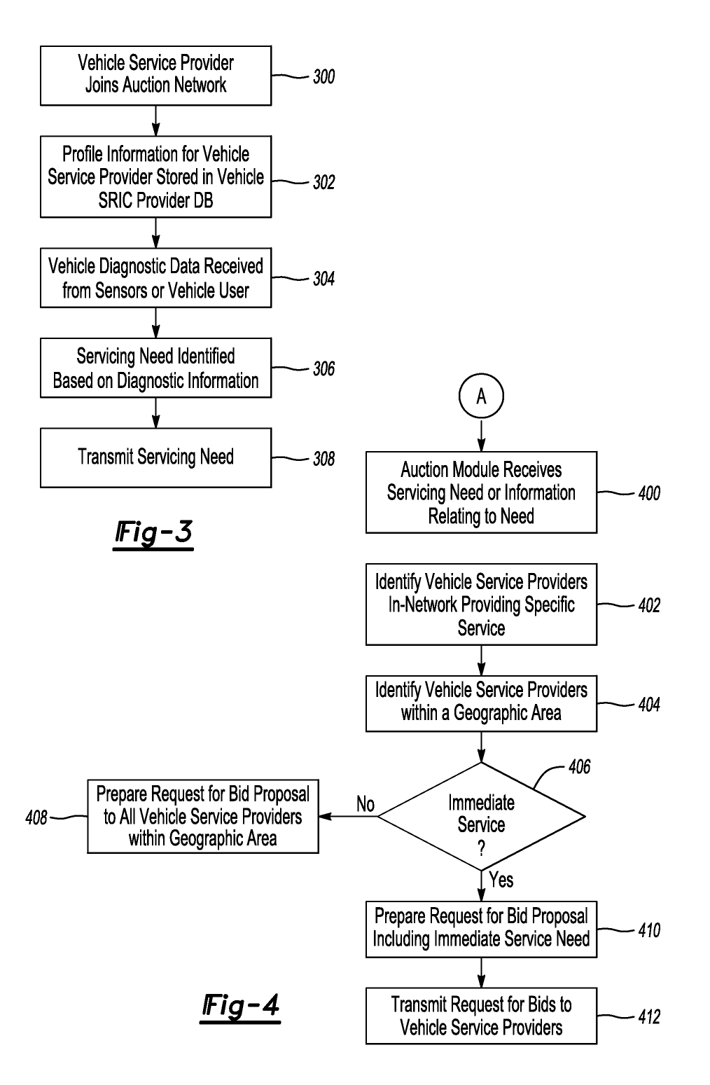

FIG. 3 illustrates a data gathering operation for the vehicle service auction system including continuously updating VSP records and collecting and transmitting vehicle diagnostic data. The database(s) 204 may be updated with new or modified VSP information periodically. Each VSP may be part of a membership network of VSPs who can participate in the vehicle service auction. Membership into the network may include the VSP registering as a service provider (block 300). During, or after, the registration process, the VSP may create and update a VSP profile as described above which is stored in database 204 (block 302).

The vehicle diagnostic data may be used to automatically trigger the auction process. When a diagnostic concern is received in the vehicle (block 304), diagnostic information from the vehicle may be transmitted to the system 200 and input to the auction module 206 to commence the vehicle service bidding process. The diagnostic information may be from the one or more sensors 144 in the vehicle and/or from user input. In the latter case, certain diagnostic information that may not be detectable by the sensor(s) 144 may be input by the user at the head unit 104. User input diagnostic problems may be those that cannot be detected by the in-vehicle sensors 144. A chipped windshield, a broken side view mirror, and issues with the entertainment module, such as the CD player or a media port, are non-limiting examples of such user input diagnostic problems. On the head unit display 110, the user may be presented with a menu of diagnostic concerns of which one or more may be selected by the user for servicing.

A servicing need for the vehicle may be determined based on the diagnostic information (block 306) and the servicing need transmitted to trigger the auction process (block 308). The service need may be determined at the head unit 104 and the service need transmitted to the system 200 via network 134. Alternatively, the service need may be determined remotely at the system 200. The latter alternative may be beneficial where, for example, the head unit is an entry level head unit configured with minimal processing and memory. As such, the processing and memory usage may be performed remotely to conserve local resources. Of course, remote processing may occur in other environments (e.g., head units with larger processing power and memory) as well.

FIG. 4 illustrates the operation relating to requesting bids from vehicle service providers. The auction process may be triggered once the servicing need, or information relating to the servicing need, has been received by the auction module 206 (block 400).

Some VSPs may not provide all types of servicing for a vehicle. Additionally, some VSPs may specialize in particular types of servicing. Based on the servicing need, the auction module 104 may determine, based on the VSP profile information, the VSPs capable of servicing the vehicle and/or specializing in the specific service need (block 402) in order to identify which VSPs to send a request for bid. In some embodiments, VSPs specializing in particular maintenance and/or repair may be associated with an identifier (e.g., stored in the database 204) to identify the VSP as a specialist. The identifier may be displayed as a graphic (such as an icon) or other visual identification indicating to the vehicle occupant that the VSP is a specialist. Alternatively or additionally, the vehicle occupant may be notified through an audible notification (e.g., and without limitation, a verbal notification).

To additionally refine the number of VSPs presented to the vehicle occupant, the VSPs within a geographic area may be searched and identified. In some embodiments, a default geographic area and/or distance may be used, which may be defined by the vehicle manufacturer (the OEM). In some embodiments, the geographic distance may be based on a geographic radius. Alternatively, the geographic area may be defined by a vehicle user. As non-limiting examples, the user may define the geographic area based on a certain distance or radius, as within a specified geographic boundary (e.g., state, city, county, or zip code), and/or as on a particular road. In further embodiments, the VSPs may be determined on, along, and/or near a navigation route. The location of the vehicle on the route may be transmitted to the server(s) 202 and used by the module 206 to identify the VSPs.

It is conceivable that the default or user-defined geographic area may be nationwide. In this case, the search may be conducted on all member VSPs nationwide. Such a search may be used, for example, when the user is travelling in the vehicle across multiple state lines.

A vehicle user may occasionally need immediate servicing on the vehicle (block 406). Immediate servicing may refer to the vehicle user's ability to bring the vehicle to the VSP for servicing and/or the servicing completed without extensive delay. As non-limiting examples, the VSP has same day servicing available, a same day appointment can be made, and/or the servicing can be completed within a definite time period (e.g., 24-48 hours). Non-limiting examples of where immediate servicing may be desired is a flat tire, an oil change, general vehicle servicing (e.g, servicing performed at certain mileage milestones), and the like.

The vehicle user may indicate whether or not immediate servicing is desired or needed through input received in the vehicle 102. The input may be received via touch-based and/or vocal commands, which may be transmitted as instructions to the auction module 206. If immediate service is not desired (block 406), a request for a bid proposal may be prepared for the VSPs in the default or user-defined geographic area (block 408). For example, if the user-defined geographic area is within a zip code, then the search and identification of VSPs within that zip code will be performed.

On the other hand, if immediate servicing is desired (block 406), a request for a bid proposal may be made for VSPs within the default or user-defined geographic area. In some alternative embodiments, the geographic area for an immediate service need may be restricted to a predefined radius. The bid proposal may include a notification that the vehicle user desires immediate service (block 410). In some embodiments, the vehicle user may also include a time for servicing, which may also be included as part of the request for bid. Based on the notification, the VSP may easily identify such requests and use this information in deciding whether or not to submit a bid. Further, in some embodiments, the information provided in the request for bid may be used to automatically schedule an appointment if the bid is submitted and accepted. For example, the appointment may be entered into an electronic calendaring program on the VSP system 208.

Once the request for bid has been prepared, the request may be transmitted to one or more VSPs within the geographic area that are able to complete the service (block 412). Further, if requested by the user, the request for bid may be sent to the one or more VSPs who can provide immediate service. The request for bid may be received by the VSP as an electronic mail message and/or as a notification on a web-based system.

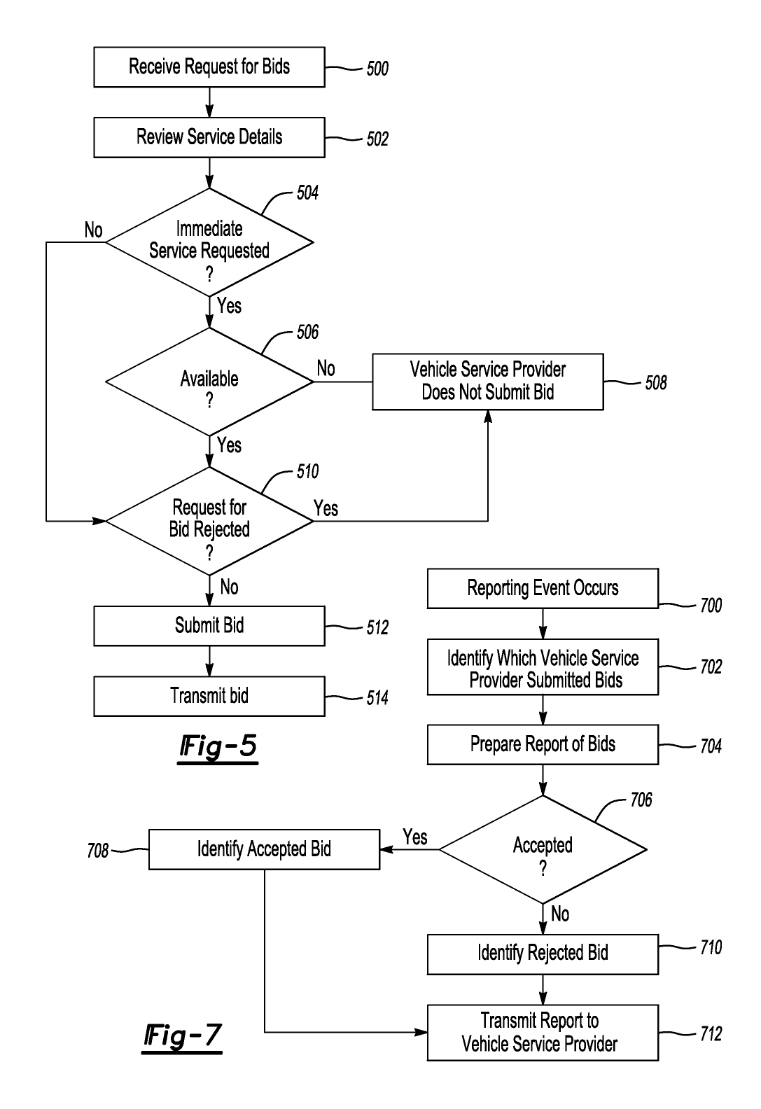

FIG. 5 illustrates the bid submission process performed by a VSP. One or more VSPs receive the request for a bid (block 500) at terminal(s) 208b. After receiving the request for bid, a VSP may review the request for service details (block 502). The service details may include vehicle information (e.g., make, model, and year), servicing need, and whether an immediate servicing is requested (if applicable). Based on the review, the VSP may determine whether staffing is available to service the vehicle, whether parts are available, when parts or personnel will be available, and other like administrative and business-related issues.

In some embodiments, the VSP system 208 may include software for automatically reviewing the request for bid. The software may be tied to and may communicate with the VSPs other systems, such as scheduling and parts inventory systems, to automatically determine whether to respond to the request for bid. Further, a bid may be submitted automatically through such software.

Based on the details in the request for bid, a determination may be made whether an immediate service need is requested (block 504). If so, a further determination may be made if the VSP can service the need immediately (block 506). The determination may be made based on, for example, parts inventory, personnel availability, the time the bid is received, the type of servicing requested, and/or the time requested by the vehicle user for servicing. If the VSP cannot immediately service the vehicle, a bid is not submitted (block 508). A bid is not submitted through passive rejection, for example, by ignoring the request for bid. As such, a time limit may be imposed within which the VSP may be required to submit the bid in response to the request. Alternatively or additionally, the VSP may reject the request actively by, for example, submitting a rejection to the request.

Notwithstanding that the vehicle can be serviced immediately, a request for bid may still be rejected by the VSP (block 510). The VSP may intentionally or unintentionally not respond to the request for bid or explicitly reject the request for bid. If the request for bid is rejected, the VSP does not submit a bid (block 508).

If immediate servicing is not requested, determining whether the VSP is available for immediate service is not performed (block 506). Rather, the process continues with determining if the request for bid was rejected (block 510). In some embodiments, the determination whether a request for bid is rejected may be made before determining whether immediate service is required.

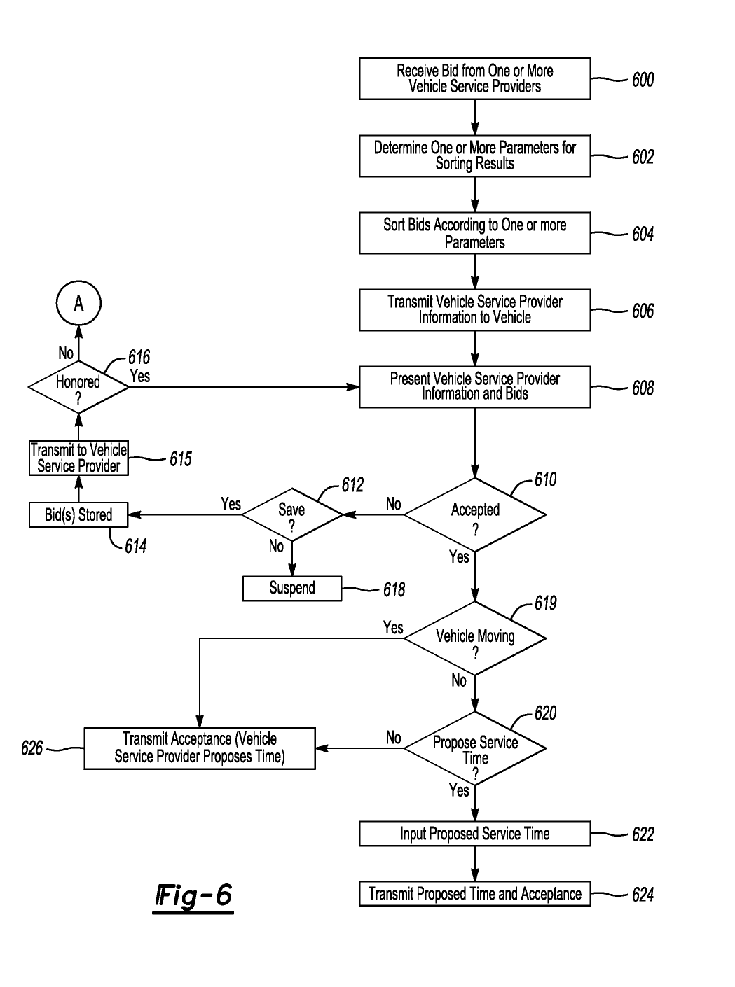

If a request for bid is not rejected, a bid is submitted (block 512) and the bid transmitted to the central auction system 200 for further action on the submitted bid (described below in FIG. 6). In some embodiments, the bid may include, in addition to the bid price, the VSPs availability, including if immediately available or available during the user request time. In some embodiments, the process may be an “opt-in” process such that request for bid is rejected unless the VSP actively submits a bid. As described above, the bids may be submitted automatically or manually.

FIG. 6 shows the operation of the vehicle service auction system after a bid is transmitted from one or more VSPs. Bids may be received from one or more VSPs by the central auction system 200. The bids may be received by the auction module 206 which may determine one or more parameters by which to sort the bid results (block 602). For example, and without limitation, the bids from the one or more VSPs may be sorted by bid amount (e.g., price), distance from the vehicle's current location, or availability (including immediate availability). In some embodiments, the user may predefine one or more preferred sorting parameters.

In some embodiments, at least one sorting parameter may be based on reviews of the service of the VSP. The ratings may be obtained from the public sources that may be accessible via the Internet or may come from other vehicle owners who post and store reviews and ratings at the system 200 (e.g., stored along with vehicle owner profile information). The ratings may be based on rankable criteria such as numbers, letters, and/or other criteria (e.g., “bad,” “good,” “very good”). The auction module may be programmed with an algorithm, such as a weighting algorithm, that ranks the ratings based on the rankable value.

Based on one or more parameters, the bids may be sorted by the auction module 206 (block 604). In some embodiments, the bids may be sorted by multiple parameters. For example, the bids may be sorted by bid amount and distance such that the one or more VSPs who are closest to the vehicle's location and who are cost effective (e.g., having the lowest bids) are presented to the vehicle occupant. Of course, any number of multiple parameters may be used.

VSP information, along with each bid, may be transmitted from the system 200 to the vehicle over network 134 (block 606) and presented to the vehicle occupant (block 608). The VSP information may be presented visually or audibly. In some embodiments, the VSP information and bids may be presented on a navigation display, e.g., as points on a route. In additional or alternative embodiments, the VSPs may be listed as points of interest (POI).

The bids may or may not be accepted by the vehicle occupant (block 610). If the bid is not accepted, the vehicle occupant may or may not save the bid results (block 612). For example, a vehicle occupant may not immediately want to accept a bid. In such cases, the vehicle occupant may save the bid results which may be stored in memory 108 or at the system 200 (block 614). In some embodiments, the stored bids may later be submitted back to the VSPs via the head unit 104 (block 615) which may be done, for example, to request whether the bids will still be honored (block 616). Whether or not the bid is honored may be determined based on instructions from the VSP which are predefined (e.g., and without limitation, an expiration of the bid offer) or determined based on instructions provided when the VSP receives the resubmitted bid. If the bid offer is still honored, VSP information and bids may be presented in the vehicle (block 608). Otherwise, the auction process may be restarted at circle block A. After the bids are stored or if the bids are not saved, then the auction process may be suspended.

Referring back to block 610, the vehicle occupant can accept one bid. Acceptance may be accomplished through verbal or non-verbal (e.g., touch-based) commands. When accepted, the vehicle occupant may be able to propose a time for service and/or modify a proposed time, if previously provided as described above. In some embodiments, for purposes of safety, the user may only propose a time if the vehicle is not moving. If the vehicle is moving (block 619), the vehicle user may transmit acceptance of a bid through a verbal or non-verbal command (block 626). Only the acceptance may be transmitted to the VSP from the vehicle 102 via system 200 and the ability to input a proposed time via the head unit 104 is locked out or otherwise unavailable. The VSP may contact the vehicle user to schedule a service time.

If the vehicle is not moving (block 619), a determination may be made whether a service time has been proposed by the vehicle user (block 620). The service time may be based on a previously proposed time or a time proposed after the bid was accepted. If a time has not been proposed, the acceptance may be transmitted and the VSP may propose a time (block 626) as described above.

Otherwise, a proposed time may be submitted via the head unit 104 (block 622). The acceptance of the bid and the proposed time may be transmitted to the VSP (block 624). The VSP may contact the vehicle user to propose a different time if the user proposed time is unavailable. Otherwise, the proposed time may be confirmed and output in the vehicle. For example, the immediate servicing request may be confirmed and a confirmation output in the vehicle.

In some embodiments, reports may be generated periodically for the member VSPs to analyze results and determine if the VSP is competitively bidding compared to other VSPs. The identity of each VSP may remain confidential. In some embodiments, reports are only transmitted and available to VSPs who submitted a bid during an auction round. FIG. 7 shows a reporting process for reporting the results of the bidding event.

System 200 may include a separate reporting module (not shown) or a reporting function may be included in the auction module 206. For a report to be generated, a reporting event may occur (block 700). Non-limiting examples of reporting events may be an acceptance by the vehicle user of a bid or a passage of time. The VSPs who submitted bids may be identified by or from the auction module (block 702) and a report of bids prepared based on the submissions (block 704).

If a bid was accepted by a vehicle user (block 706), the accepted bid is identified and reported (block 708). Otherwise, the report may show that no bids were accepted or which of the submitted bids were rejected and which bid(s) was accepted (block 710). Once the information is gathered and generated, the report is transmitted to the VSP (block 712) via electronic mail and/or may be uploaded to the server 202 for review and/or download by the VSP via terminal(s) 208b.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method for presenting one or more vehicle service providers on a vehicle computing system, the computer-implemented method comprising:
receiving vehicle diagnostic information at a vehicle computing system;
transmitting the diagnostic information from the vehicle computing system to a vehicle servicing bidding module configured to manage a vehicle service bidding operation, the vehicle service bidding operation including submitting requests for bids to one or more vehicle service providers and receiving one or more bids from the one or more vehicle service providers for servicing the vehicle based on a servicing need determined from the vehicle diagnostic information;
receiving at the vehicle computing system the one or more bids from the one or more vehicle service providers;
outputting the one or more bids at the vehicle computing system;
displaying location information for the one or more vehicle service providers from whom the one or more bids are received, the location information being displayed as points of interest on a navigation map at the vehicle computing system;
receiving a user selection of a bid from the one or more bids from the one or more vehicle service providers at the vehicle computing system;
based on the location information, generating a route to the vehicle service provider whose bid was selected by the user.

2. The computer-implemented method of claim 1 wherein the location information is stored in a database remote from the vehicle computing system, the computer-implemented method further comprising automatically inputting the location information received at the vehicle computing system from the database to a navigation module at the vehicle computing system for generating the route.

3. (canceled)

4. The computer-implemented method of claim 1 further comprising:
receiving a request at the vehicle computing system for a specified service time; and
transmitting the request for the specified service time from the vehicle computing system, wherein the request for the specified servicing time is submitted with the requests for bids, wherein receiving the bids includes receiving bids from the one or more vehicle service providers that can service at the requested service time.

5. The computer-implemented method of claim 4 wherein the specified service time is for immediate servicing.

6. The computer-implemented method of claim 1 wherein the bid selection is received orally.

7. A system for providing at a vehicle computing system one or more vehicle service providers along a route, the system comprising:
at least one computer configured to:
receive a servicing need for a vehicle;
receive a location of the vehicle;
based on the servicing need and the location of the vehicle, identify one or more vehicle service providers within a geographic area able to service the servicing need; and
in response to receiving the servicing need, automatically initiate a vehicle servicing bidding event with one or more vehicle service providers within the geographic area who are able to service the servicing need;
upon completion of the vehicle servicing bidding event, sort all received bids based on an amount of the bid;
transmit the sorted bids for output from a vehicle computing system;
receive a user selected bid transmitted from the vehicle computing system;
identify the vehicle service provider winning the user selected bid; and
automatically transmit appointment information into an electronic calendar system of the vehicle service provider's.

8. The system of claim 7 wherein the at least one computer is further configured to:
initiate a timer during the vehicle servicing bidding process for monitoring a time period for receiving the bids from the one or more vehicle service providers; and
transmit bids which are received within the time period as determined based on the timer.

9. The system of claim 7 wherein the at least one computer is further configured to receive the location of the one or more vehicle service providers and services of the one or more vehicle service provider from a database communicating with the at least one computer to identify the one or more vehicle service providers.

10. The system of claim 7 wherein the at least one computer is further configured to:
receive a request for a specified service time; and
transmit the request for the specified servicing time with one or more requests for bids during the vehicle servicing bidding event, wherein each of the one or more vehicle service providers submit a bid based on whether the service can be performed at the specified servicing time.

11. The system of claim 10 wherein the vehicle servicing bidding event further includes receiving bids from the one or more vehicle service providers within the geographic area who are able to service the servicing need at the specified servicing time.

12. The system of claim 12 wherein the specified service time is for immediate servicing.

13. The system of claim 7 further comprising a vehicle computing system configured to:
receive the bids from the one or more vehicle service providers;
output the bids at the vehicle computing system;
receive a user selection of a bid;
output location information for the vehicle service provider who submitted the user selected bid; and
generate a route to the vehicle service provider based on the location information.

14. The system of claim 13 wherein the location information is stored in a database remote from the vehicle computing system, the vehicle computing system being further configured to automatically input the location information received from the database to a navigation module at the vehicle computing system for generating the route.

15. The system of claim 7 wherein the at least one computer is further configured to sort the bids based on at least one of bid amount and distance of the vehicle service provider from the vehicle.

16. The system of claim 7 wherein the servicing need is based on diagnostic information detected by one or more vehicle sensors.

17. The system of claim 7 wherein the servicing need is user defined.

18. A computer program product embodied in a non-transitory computer readable medium for presenting at a vehicle computing system one or more vehicle service providers along a route, the computer program product having instruction for:
receiving a servicing need for a vehicle;
receiving a location of the vehicle;
based on the servicing need and the location of the vehicle, identifying one or more vehicle service providers within a geographic area able to service the servicing need;
automatically triggering a vehicle servicing bidding event in response to receiving the servicing need, wherein one or more bids are received from one or more vehicle service providers within a geographic area and capable of servicing the servicing need;
transmitting the one or more bids for output at a vehicle computing system;
receiving an instruction to save the one or more bids in memory; and
storing the bids in memory for a predefined period of time.

19. The non-transitory computer program product of claim 18 further comprising instructions for:
sorting the bids based on an amount of the bid; and
transmitting the sorted bids for output from a vehicle computing system.

20. The non-transitory computer program product of claim 18 wherein the vehicle service provider location is within a radius of the vehicle.

21. The non-transitory computer program product of claim 18 wherein the predefined period of time is based on an expiration of an offer contained in the bid from the one or more vehicle service providers.
